(19) United States
(12) Patent Application Publication
(10) Pub. No.: US 2015/0015807 A1
(43) Pub. Date: Jan. 15, 2015

(54) GLASS-SURFACE COMPOSITE FOR ARRANGEMENT IN FRONT OF A VISUAL DISPLAY, IN FRONT OF AN OPERATING PANEL OR FOR USE AS A DECORATIVE ELEMENT

(71) Applicants: THOMAS FRANKE, LAUPHEIM (DE); Michael Boettinger, Neu-Ulm (DE)

(72) Inventors: THOMAS FRANKE, LAUPHEIM (DE); Michael Boettinger, Neu-Ulm (DE)

(73) Assignee: e.Solutions GmbH, Ingolstadt (DE)

(21) Appl. No.: 14/321,460

(22) Filed: Jul. 1, 2014

(30) Foreign Application Priority Data
Jul. 12, 2013 (DE) 102013011690.2

(51) Int. Cl. G06F 1/16; B32B 17/06; B32B 7/12

(52) U.S. Cl. CPC G06F 1/1643; B32B 7/12; B32B 17/064; B32B 2250/03; B32B 2250/04; B32B 2307/558
USPC 349/12; 428/337; 428/336; 428/335

(57) ABSTRACT

A glass-surface composite is described for arrangement in front of a visual display, in front of an operating panel and/or for use as a decorative element, in particular in a motor vehicle. The glass-surface composite comprises a glass layer provided by way of surface, a flexible backing layer and an adhesive layer which connects the glass layer to the backing layer two-dimensionally. In addition, a tablet computer is described that includes such a glass-surface composite.

### TECHNICAL FIELD

The present disclosure relates generally to the field of crash-safe glass surfaces. It relates, in particular, to a glass-surface composite for arrangement in front of a visual display, in front of an operating panel and/or for use as a decorative element, for example in a motor vehicle.

### BACKGROUND

Visual displays are increasingly gaining in importance in the interior of motor vehicles. The conventional function of visual displays, namely to inform the driver at any time of significant aspects of the condition of the vehicle, has been steadily broadened. In recent years further functions have been added, such as, for instance, the visualisation of satellite-supported route guidance or the provision of entertainment media for passengers. A continuation of this development towards more visual displays in the interior of motor vehicles is to be expected as a result of the spreading use of tablet PCs. In this regard, particularly in the automobile sector, there is interest in providing tablet PCs at several seating positions in the passenger compartment.

In the area of automobile applications and the like, however, in the case of visual displays, and especially in the case of installed tablet PCs, problems arise by virtue of the fact that these displays or operating elements have been arranged in the field of vision, i.e. as a rule in front of the occupant of the vehicle. Hence, on the one hand, the risk of body parts colliding with the display in the event of a traffic accident is very high. At the same time there is a high risk of injury for occupants of the vehicle in the event of a cover glass of the display shattering and shards flying around. Therefore visual displays often constitute a particular source of danger in the interior of motor vehicles.

Solutions with which a degree of crash safety for visual displays can be achieved that satisfies the current safety requirements have already been known for quite a long time. Requirements of such a type have, for example, been defined with respect to a head-impact test.

In the known solutions, use is mostly made of non-splintering plastic instead of glass by way of surface of visual displays. In addition, particularly in the case of tablet PCs for automobile applications, it is known to cover the cover glass of the display with a cut-resistant plastic film. In the event of a fracture of the cover glass (hereinafter also designated as ‘rigid cover layer’), for instance by virtue of the impingement of an occupant of the vehicle in the event of an accident, this plastic film serves to reliably hold in check the shards and fragments arising underneath.

As a disadvantage of such plastic surfaces, it has become evident that these are considered by many users to be less visually appealing and inferior in comparison with glass. In addition, with the use of plastic surfaces for the displays of tablet PCs problems arise from the fact that these surfaces are not scratch-resistant, this being disadvantageous especially in the case of a touch function of the display. With the use of restraining plastic films by way of covering, a further factor is that such surfaces wear out easily and an optical antireflection coating of the films is costly or, once again, is not compatible with a touch function of the display. Problems of such a type do not exist in the case of surfaces made of glass.

In practice it has become evident that an availability of crash-safe glass surfaces for automobile display and operating elements and also for other areas is desirable. For instance, crash-safe glass surfaces could also be employed in the area of decorative elements in the vehicle or elsewhere.

### SUMMARY

Therefore surface composites are to be specified that possess a glass surface and that, at the same time, satisfy the requirements as regards crash-safety and functionality.

According to a first aspect, a glass-surface composite is specified (e.g., for arrangement in front of a visual display, in front of an operating panel and/or as a decorative element, e.g., in a motor vehicle). The glass-surface composite comprises a glass layer provided by way of surface, with a thickness between 20 μm and 400 μm, a flexible backing layer and a first adhesive layer which connects the glass layer to the backing layer two-dimensionally.

The glass layer and/or the first adhesive layer may be completely or partly transparent.

The first adhesive layer may possess a hardness between 0 Shore A and 60 Shore A, for example between 15 Shore A and 45 Shore A. Alternatively or in addition to this, the first adhesive layer may exhibit a thickness between 5 μm and 600 μm, for example between 5 μm and 50 μm or 300 μm and 500 μm. The first adhesive layer may generally comprise acrylic, silicone or another suitable material. Furthermore, the first adhesive layer may take the form of a composite consisting of two or more adhesive laminations.

At least one side of the glass layer may have been roughened. For instance, the upper side and/or the underside of the glass layer may have been roughened. A profile depth in this case may amount to between 2 μm and 30 μm (e.g., between 5 μm and 15 μm). Alternatively or in addition to this, an average roughness between Sₐ=0.1 and 2 micrometers may be present. Alternatively or in addition to this, −2<Sₛₖ<2 (e.g., −0.2<Sₛₖ<0.2) and/or −3.5<Sₖᵤ<4.0 (e.g., 0<Sₖᵤ<4.0 or 0<Sₖᵤ<3.5) may hold. The roughness parameters may be selected such that an approximately Gaussian distribution is obtained (e.g., Sₛₖ≈0 and Sₖᵤ≈3.0). The roughening of the glass layer may be effected in different ways, for instance by means of sandblasting or chemical processes.

The glass layer may consist of hardened glass. The hardening may be effected, for example, by chemical means. A thickness of the glass layer may range between 25 μm and 300 μm (e.g., between 50 μm and 250 μm). The thickness of the glass layer may be such that said layer is flexible at room temperature. Generally the glass-surface composite may be flexible at room temperature.

For decorative purposes the glass layer may have been stained and/or provided with a decoration. Additionally or as an alternative to this, the backing layer may also have been stained and/or provided with a decoration.

The backing layer may exhibit a thickness between 50 μm and 500 μm. For instance, the thickness may be between 100 μm and 300 μm. The backing layer may be tear-resistant and cut-resistant.

The backing layer may have been realised as a composite consisting of two or more backing laminations. In this case the backing layer may include at least one plastic film. Alternatively or additionally to this, the backing layer may include an optical polarizer (e.g., in the form of a plastic film with polarizing properties). Furthermore, the backing layer may, additionally or as an alternative to this, include a layer taking the form of a touch sensor. The touch sensor may be part of an operating panel and/or of a touch-sensitive visual display which has been arranged behind the glass-surface composite.

The glass-surface composite may, in addition, include a subsurface and a transparent second adhesive layer which connects the backing layer to the subsurface two-dimensionally. In this case the subsurface may be non-planar, and the overlying layers of the glass-surface composite may have been moulded onto the subsurface. For example, the subsurface may be curved in concave, convex or some other manner (e.g., along a single predetermined axis or several axes parallel or non-parallel to one another). The curvature may have been provided in a central region or in a marginal region of the subsurface, or may extend over the entire subsurface.

Generally the subsurface may form with a visual display a system composite. In this case the subsurface may have been connected to the visual display or may be part of the latter. However, it is also conceivable that the subsurface has been provided in a manner spaced from the visual display.

The subsurface may be a rigid cover layer of a visual display and/or of an operating panel. The operating panel may include a touch-sensitive panel (e.g., of a touchscreen).

According to a second aspect, a further glass-surface composite is presented (e.g., for arrangement in front of a visual display, in front of an operating panel and/or for use as a decorative element, e.g., in a motor vehicle). Said composite comprises a glass layer provided by way of surface, with a thickness between 20 μm and 400 μm, a covering layer for the visual display and an (e.g., transparent) adhesive layer which exhibits a thickness between 5 μm and 600 μm and also a hardness between 0 Shore A and 60 Shore A, the adhesive layer connecting the glass layer to the rigid cover layer two-dimensionally.

In the glass-surface composite according to the second aspect the glass layer may exhibit, for example, a thickness between 25 μm and 250 μm.

In the surface composites that have been described the rigid cover layer may be a constituent of the covering for a visual display and/or for an operating panel in the form of a motor-vehicle instrument or instrument system, a constituent of the covering of a video screen and/or a constituent of a tablet computer for installation in the interior of a motor vehicle. In addition, the rigid cover layer may exhibit a thickness between 0.2 mm and 2 mm. The rigid cover layer may, according to all the aspects presented herein, comprise polyethylene terephthalate (PET), polyamide (PA), polycarbonate (PC), polymethyl methacrylate (PMMA) or glass.

According to a third aspect, a tablet computer is specified that includes a glass-surface composite according to the features described above.

According to a fourth aspect, a touch-sensitive screen is specified. The screen comprises a glass-surface composite according to the features described above, a rigid cover layer, a polarization layer arranged beneath the rigid cover layer, a touch sensor layer arranged beneath the polarization layer, and a display of the touch-sensitive screen.

### BRIEF DESCRIPTION OF THE DRAWINGS

Further advantages, particulars and features of the devices described herein will become apparent from the following description of exemplary embodiments and also from the Figures. Shown are:

FIG. 1a a schematic view of an exemplary embodiment of a surface composite for covering a visual display with an overlying rigid cover layer made of glass;

FIG. 1b a schematic illustration of the fracture behaviour of the surface composite according to FIG. 1a;

FIG. 2a a schematic view of an exemplary embodiment of a surface composite for covering a visual display with a rigid cover layer made of glass and with an affixed cut-resistant film;

FIG. 2b a schematic illustration of the fracture behaviour of the surface composite according to FIG. 2a;

FIG. 3a a schematic view of an exemplary embodiment of a surface composite for covering a visual display with a rigid cover layer, with an affixed cut-resistant film and with a glass layer affixed over the film;

FIG. 3b a schematic illustration of the fracture behaviour of the surface composite according to FIG. 3a;

FIG. 4 a schematic view of an exemplary embodiment of a glass layer of a surface composite with roughened surfaces;

FIG. 5a a schematic view of an exemplary embodiment of a surface composite for covering a visual display with a rigid cover layer, with a cut-resistant adhesive layer and with a glass layer arranged on the adhesive layer;

FIG. 5b a schematic illustration of the fracture behaviour of the surface composite according to FIG. 5a;

FIG. 6 application examples of a surface composite for covering a visual display in a motor vehicle;

FIG. 7a a schematic view of an exemplary embodiment of a touch-sensitive screen comprising a surface composite;

FIG. 7b a schematic illustration of the fracture behaviour of the screen according to FIG. 7a;

FIG. 8a a schematic view of a further exemplary embodiment of a touch-sensitive screen comprising a surface composite; and

FIG. 8b a schematic illustration of the fracture behaviour of the screen according to FIG. 8a.

### DETAILED DESCRIPTION

FIG. 1a shows a schematic view of a comparative example of a surface composite 100 for covering a visual display. In this case, below an overlying rigid cover layer 101 made of glass further layers 102, 103 are located. The arrow additionally represented in FIG. 1a symbolises a force such as acts, for example, in the event of an impingement of an object on the surface composite 100.

FIG. 1b shows schematically the fracture behaviour of the surface composite 100 according to FIG. 1a under the influence of the force represented in FIG. 1a. With regard to a risk of injury, varying effects arise out of the fracture properties of the rigid cover layer 101 and also out of the position of the rigid cover layer 101 on the surface of the surface composite 100. Due to the thickness of the rigid cover layer 101 of up to several millimeters, an eruption of free shards 110, entailing a risk of injury, from the thickness of the material layer may occur. In addition, fracture edges 111 of a depth entailing a risk of injury also arise on the fragments that are held back in the surface composite.

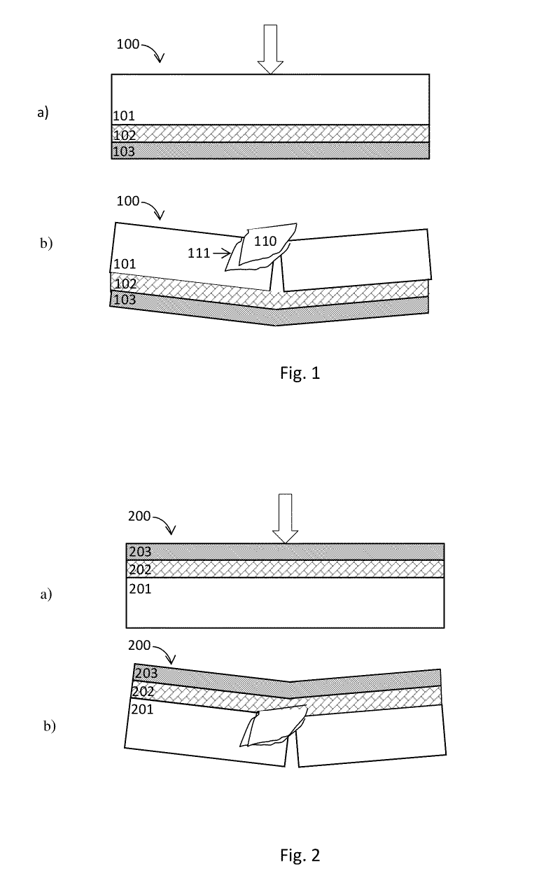

With a view to avoiding the risks of injury described with reference to FIGS. 1a and 1b, rigid cover layers made of fracture-resistant plastic could be utilised instead of glass. In this connection, FIG. 2a shows a schematic view of a further comparative example of a surface composite 200.

The surface composite represented in FIG. 2a comprises as essential constituents a rigid cover layer 201, above this an adhesive layer 202 and also, by way of surface, a cut-resistant plastic film 203 which has been adhesion-bonded to the rigid cover layer 201 by the adhesive layer 202. The arrow additionally represented in FIG. 2a symbolises a force such as acts, for example, in the event of an impingement of an object on the surface composite 200.

FIG. 2b shows a schematic view of the fracture behaviour of the surface composite according to FIG. 2a under the influence of the force represented in FIG. 2a. In this case, the layers 202, 203 arranged above the rigid cover layer 201 prevent a protrusion of fracture edges from the surface composite 200.

While the surface composite according to FIG. 2a effectively reduces the risks of injury in the event of an impingement, the surface of the composite does not consist of glass. However, it has become evident that, both for the visual and haptic sensing of the surfaces by the user and also with regard to the functionality and durability of coverings for visual displays, a surface made of glass is to be preferred.

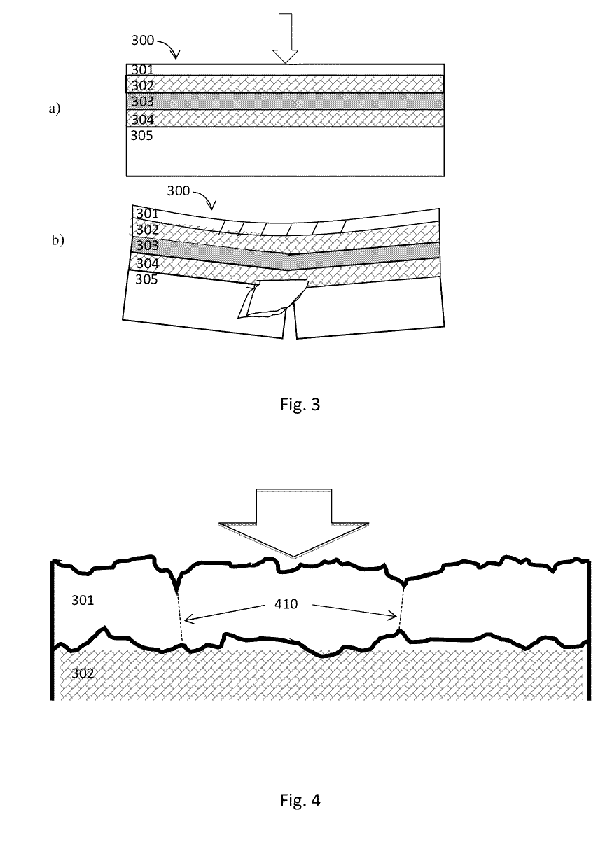

FIG. 3a shows a schematic view of an exemplary embodiment of a surface composite 300, for example, for arrangement in front of a visual display. In the embodiment that is represented, the surface composite 300 comprises a transparent glass layer 301 provided by way of surface, a first transparent adhesive layer 302, a transparent flexible backing layer 303, a second transparent adhesive layer 304 and a rigid cover layer or some other subsurface 305. In this case the glass layer 301 possesses a thickness between 20 μm and 400 μm. The first adhesive layer 302 connects an underside of the glass layer 301 to an upper side of the backing layer 303 two-dimensionally. The backing layer 303 in this case is designed to be tear-resistant and cut-resistant. The second adhesive layer 304 connects an underside of the backing layer 303 to the subsurface 305 two-dimensionally. The arrow additionally represented in FIG. 3a symbolises a force such as acts, for example, in the event of an impingement of an object on the surface composite 300.

FIG. 3b shows a schematic representation of the fracture behaviour of the surface composite 300 according to FIG. 3a under the influence of the force represented in FIG. 3a. Corresponding to the comparative example as shown in FIGS. 2a and 2b, in the surface composite 300 in FIGS. 3a and 3b the lower partial composite consisting of flexible backing layer 303, second adhesive layer 304 and rigid cover layer 305 also serves to prevent a protrusion of fracture edges entailing a risk of injury from the surface composite 300 in the event of a fracture of the rigid cover layer 305. This happens by virtue of the fact that shards and fracture edges of the smashed rigid cover layer 305 (e.g., after a car crash) are held in check with the aid of the affixed tear-resistant and cut-resistant backing layer 303. By way of significant difference from the surface composite 200 according to FIGS. 2a and 2b, however, the surface composite 300 in FIG. 3 exhibits, in addition, a first adhesive layer 302 and also a glass layer 301 above the flexible backing layer 303, the glass layer 301 forming the surface of the surface composite 300.

Given sufficiently thin design of the glass layer 301, said layer exhibits a relatively high flexibility and hence pliability. Hence the risk of damage to the glass layer 301 by the customary operational loading (for instance, for a video screen with touch function) falls. At the same time, in the event of a possible fracture of the glass layer 301 as a result of an impingement a risk of injury by the fragments arising is diminished by reason of the pliability thereof. In addition, given sufficiently low rigidity of the glass layer 301 and, at the same time, sufficiently firm adhesion of the glass layer 301 to the flexible backing layer 303 with the aid of the first adhesive layer 302, in the event of a smashing of the glass layer 301 the fracture edges of the glass layer 301 cannot project far from the surface composite 300 in a manner entailing a risk of injury. In addition, on account of the thin design of the glass layer 301 it is not possible for shards of a thickness entailing a risk of injury to erupt from the material thickness of the glass layer 301. Instead of this, a smashed glass layer 301 exhibits, very largely, vertical fractures or cracks through the entire layer thickness, the fragments of the glass layer 301 that are formed being effectively held in the surface composite 300 by the first adhesive layer 302 situated below said glass layer.

For the described fracture behaviour of the glass surface the interaction of low rigidity of the glass layer 301 and high strength of the underlying adhesive bond with the aid of the first adhesive layer 302 is essential. In order to guarantee sufficient crash safety, the glass layer 301 has been designed to be sufficiently thin. At the same time, the use of the surface composite 300 for the purpose of covering an operating panel or a video screen with touch function makes demands as regards a mechanical minimal load-bearing capacity of the glass layer 301.

A layer thickness between 50 μm and 200 μm for the glass layer 301 has proved expedient. Whereas, in addition, the use of borosilicate glass has proved worthwhile, other glasses, e.g., chemically hardened glasses, can also be used for the glass layer 301. Generally suited are, for example, glass types Schott D263, Schott Xensation, Asahi Dragontrail and Corning Gorilla I/II/III.

The specifications of the first adhesive layer 302 also result from the properties of the glass layer 301 being used. In this connection, a hardness of the adhesive layer 302 between 0 Shore A and 60 Shore A and also a thickness of the adhesive layer of about 100 μm to 400 μm has been shown to be advantageous. Positive results can, however, be achieved for a thickness of the first adhesive layer 302 within the range between 5 μm and 500 μm. Suitable as adhesive are adhesives based on acrylic or silicone.

FIG. 4 shows an example of a partial composite consisting of glass layer 301 and first adhesive layer 302, wherein for the purpose of enhancing anti-glare properties and also the haptic characteristics the surface of the glass layer 301 has been roughened. The profile depth in this case may amount to between 2 μm and 20 μm, and the average roughness to between Sₐ=0.1 and 2 micrometers (e.g., with −2<Sₛₖ<2 and/or with −3.5<Sₖᵤ<3.5, such as with −0.2<Sₛₖ<0.2 and/or 2.75<Sₖᵤ<3.25). In one variant, the average roughness is selected that a Gaussian distribution of the roughness parameters such as Sₛₖ and/or Sₖᵤ results. Such a structuring of the surface of the glass layer 301 has a favourable effect, in the manner of predetermined breaking-points 410, on the fracture behaviour of the glass layer. A likewise roughened underside of the glass layer 301 further reinforces this effect and guarantees, at the same time, a firmer connection of the glass layer 301 to the underlying first adhesive layer 302. It will be understood that for the purpose of achieving the predetermined breaking-points 410 the roughening of one of the two sides of the glass layer 301 is sufficient (e.g., the upper side or the underside).

The above described thickness and roughness characteristics of the glass layer 301 can be achieved, and controlled, for example, by exposing one or both surfaces of a plane glass plate to an etching process. In that case, due to the controlled removal of material, a glass plate may be chosen that has a substantially larger thickness than the thickness intended for the glass layer 301.

The function of the flexible backing layer 303 is decisive for the fracture behaviour of the surface composite 300. In this connection the backing layer 303 may consist of a plastic film, with a thickness between 30 μm and 500 μm being suitable. Since in the surface composite 300 according to FIGS. 3a and 3b the flexible backing layer 303 has been completely embedded in the surface composite 300, the flexible backing layer 303 may also contain an optical polarizer (linear or circular) and/or a touch sensor. These components are, for the most part, not suitable by way of surface of display coverings and/or operating-panel coverings, but may possess the requisite mechanical flexibility with regard to a deformability of the glass layer 301 and/or load-bearing capacity for the purpose of holding in check a broken rigid cover layer 305.

For the purpose of enhancing the crash safety, the rigid cover layer 305 may consist of plastic, such as, for example, polyethylene terephthalate (PET), polyamide (PA), polycarbonate (PC) or polymethyl methacrylate (PMMA), instead of glass. The rigid cover layer exhibits, in addition, a thickness, for example, between 0.2 mm and 2 mm.

The surface composite 300 shown in FIGS. 3a and 3b comprises the layers necessary for illustrating the fundamental functional principle. The technical teaching presented herein may, however, also be put into practice by a large number of divergent designs, e.g., with further material laminations below, or instead of, the rigid cover layer 305, within the first adhesive layer 302 and/or within the backing layer 303.

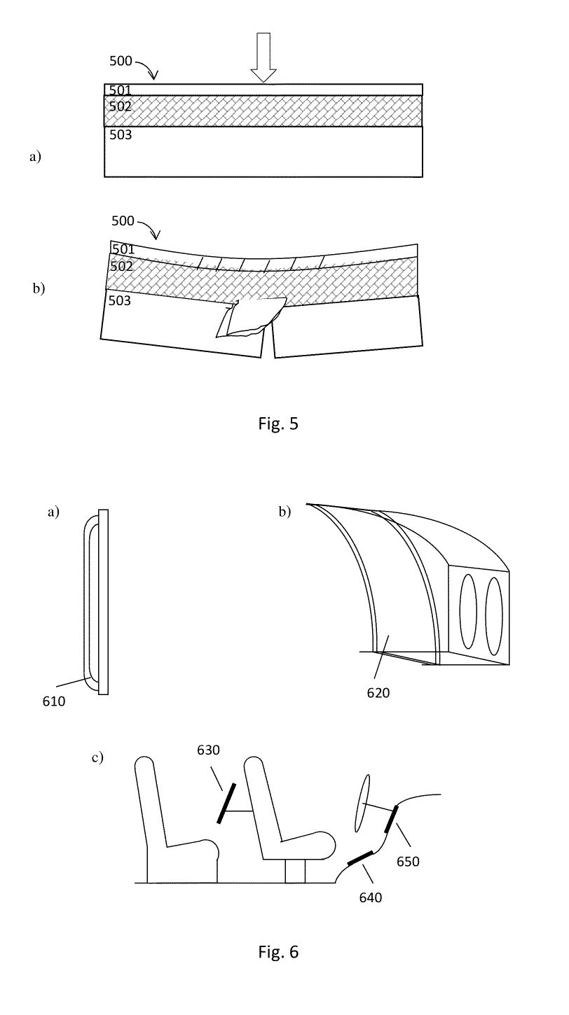

FIG. 5a shows an alternative exemplary embodiment, wherein the surface composite 500 represented comprises a transparent glass layer 501, a transparent adhesive layer 502, which has been arranged below the glass layer, and also a rigid cover layer 503 which has been arranged below the adhesive layer. In this case the glass layer has a thickness between 20 μm and 400 μm, and the adhesive layer a thickness between 5 μm and 500 μm and also a hardness between 0 Shore A and 60 Shore A. In addition, the adhesive layer connects the glass layer to the rigid cover layer two-dimensionally. The arrow additionally represented in FIG. 5a symbolises a force such as acts, for example, in the event of an impingement of an object on the surface composite 500.

FIG. 5b shows a schematic representation of the fracture behaviour of the surface composite 500 according to FIG. 5a under the influence of the force represented in FIG. 5a. In the surface composite represented in FIGS. 5a and 5b the adhesive layer 502 serves for holding shards and fracture edges in check in the event of a smashing of the rigid cover layer 503 according to the flexible backing layer 303 in FIGS. 3a and 3b. At the same time, however, the adhesive layer 502 also serves for sufficiently firm adhesion bonding of the glass layer 501 situated above the adhesive layer 502 according to the first adhesive layer 302 in FIGS. 3a and 3b. Hence in the embodiment according to FIGS. 5a and 5b the adhesive layer 502 combines the functions, described previously with respect to the example shown in FIGS. 3a and 3b, of first adhesive layer 302, flexible backing layer 303 and second adhesive layer 304.

The above remarks relating to FIGS. 3a, 3b and 4 with respect to the interaction of glass layer 301 and its adhesion bonding 302 and also with respect to the properties of glass layer 301 and rigid cover layer 305 also apply in like manner to the surface composite 500 shown in FIGS. 5a and 5b. In particular, also in the practical form according to FIGS. 5a and 5b the rigid cover layer 503 for enhancing the crash safety may consist of plastic, such as, for example, polyethylene terephthalate (PET), polyamide (PA), polycarbonate (PC) or polymethyl methacrylate (PMMA), instead of glass. The rigid cover layer 503 exhibits, besides, a thickness, e.g., between 0.2 mm and 2 mm. In addition, also in the case of the practical form according to FIGS. 5a and 5b at least one surface of the glass layer 501 may have been roughened.

The good laminating capacity of thin glass layers by reason of the pliability thereof proves advantageous for an application of the glass surfaces presented herein onto uneven covering layers. This allows a series application of the described glass surfaces at room temperature on an uneven subsurface, for example a subsurface that is curved along a (single) axis. As shown in FIGS. 6a and 6b, in particular operating-panel and display coverings with rounded edges 610 (e.g., in the case of tablet computers) or two-dimensionally curved coverings 620 in front of vehicle instrument panels with speedometer, tachometer, etc. enter into consideration for this purpose.

For example, as represented schematically in FIG. 6c, the surface composite that has been presented may be a constituent of a tablet computer 630 for installation in the interior of a motor vehicle. In this connection the tablet computer may have been detachably or permanently fastened at the rear to the seat of the driver or front passenger and hence may be operable for passengers on the rear seats. Alternatively, the surface composite may also be a constituent of a navigation tool 640, a tablet computer 650 or any instrument in the front seat area of a motor vehicle.

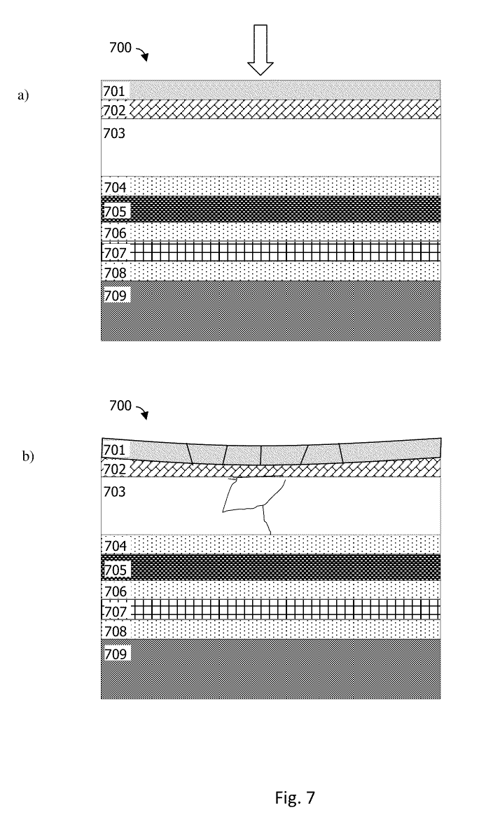

FIG. 7a shows an exemplary embodiment of a touch-sensitive screen 700 (e.g., for use in a motor vehicle). The screen 700 has a surface composite of the described kind. The touch-sensitive screen 700 may be a constituent of a tablet computer 630, 650, a navigation tool 640, or any other instrument.

The screen 700 comprises a transparent glass layer 701, a transparent adhesive layer 702, which has been arranged below the glass layer, and also a rigid cover layer 703 which has been arranged below the adhesive layer. The surface composite 701, 702, 703 shown in FIG. 7a thus resembles the surface composite 500 of FIGS. 5a and 5b.

The screen 700 further comprises a polarization layer 705 arranged beneath the rigid cover layer 703, a touch sensor layer 707 arranged beneath the polarization layer 705, and a display 709 of the touch-sensitive screen 700. These are bonded to one another and to the rigid cover layer 703 by further adhesive layers, comprising a first 704, a second 706 and a third further adhesive layer 708.

The screen 700 has been optimized for good haptic properties in combination with low reflection of ambient light, while also fulfilling the durability and safety requirements as posed, for example, by the use in a motor vehicle. The glass layer 701 has a roughened surface in order to avoid direct reflections, or glares, of ambient light without requiring sensitive anti-reflection coating. A roughened structure additionally leads to an improvement in the haptic properties of the surface 701 because, on touching the screen, a finger moves more easily over a roughened surface (and more precise control of the touch function is accordingly possible) than over a high-gloss, that is to say smooth, surface optionally provided with an optical coating, to which a finger often appears to stick when it is moved.

Because the roughening of the surface 701 also affects the transmitted light of the display 709, the chosen roughness is adapted to the resolution of the display 709 in order to optimise the screen display. An average roughness in the range between Sₐ=0.17 and 0.25 micrometers, e.g., between 0.188 and 0.192 micrometers, with −0.2<Sₛₖ<0.2 and with 2.8<Sₖᵤ<3.2, i.e., with an at least approximately Gaussian distribution, has been found to be suitable, but positive results are to be achieved for a broader roughness range of approximately between Sₐ=0.1 and 2 micrometers with −2<Sₛₖ<2 and/or with 0<Sₖᵤ<4.0 as well as for a profile depth S_{z} between 2 and 30 micrometers.

The roughness can thereby be adapted to the resolution of the screen display according to subjective judgement on the basis of the surface gloss. Thus, a higher resolution is usually accompanied by a lower roughness. A roughness corresponding to a gloss between 20 and 150 gloss units, GU, e.g., around 40 GU, has been found to be suitable. The gloss can be measured at an angle of 60 degrees for gloss units between approximately 20 and 70. Above approximately 70 to 80 gloss units, measurements can be performed at an angle of 20 degrees. Moreover, in connection with the sparkling characteristics of the surface, a Gaussian distribution of the roughness parameters was found to be advantageous in some implementations.

In the exemplary embodiment according to FIG. 7a, the polarization layer 705 beneath the rigid cover layer 703 serves to absorb incident light. The use of circular polarizers, comprising a linear polarizer in conjunction with an underlying λ/4 layer for a wavelength in the middle visible light spectrum, already shows very good results. These can be improved further, e.g., in relation to a broadened absorption spectrum, if a λ/2 layer is additionally arranged beneath the λ/4 layer of the polarization layer 705. For example, the usual red or blue sheen of screens when the display 709 is switched off can thereby be reduced in particular.

The touch sensor layer 707, in dependence on the polarization layer 705 used, can be applied to an isotropic plastics film. In the exemplary embodiment according to FIG. 7a, the touch sensor layer 707 is firmly embedded by means of a second 706 and third further adhesive layer 708 between the polarization layer 705 and the display 709 of the touch-sensitive screen 700. While such bonding of the touch sensor layer 707 both at the top and at the bottom is advantageous for the optical and mechanical properties of the screen 700, it would also be possible in an alternative embodiment to omit the third adhesive layer 708 and replace it with an air gap. This would simplify the production of the touch-sensitive screen 700. In addition, in order to improve the optical properties, each of the further adhesive layers 706, 708 used can be produced by optical bonding, that is to say by a bond that minimises disruptive optical interface phenomena between the layers.

In the exemplary embodiment, the touch sensor layer 707 comprises a capacitive touch sensor. However, alternative embodiments can also provide different types of sensor. In addition, the display 709 is a conventional liquid crystal panel. Here too, however, alternative embodiments can provide different display systems, such as a liquid crystal panel with an OLED backlight unit or an OLED display panel.

A use of the touch-sensitive screen 700 shown in FIG. 7a for installation in a motor vehicle requires high resistance to extreme temperatures and temperature variations as well as to humidity and humidity variations. Requirements made of screens for installation as standard in motor vehicles provide that the optical and mechanical properties of the screen and its components, e.g., the polarizers, do not exhibit noticeable impairment even after at least 500 hours' continuous exposure to an ambient temperature of 60° Celsius at a relative humidity between 92 and 95 percent or after at least 500 hours' continuous exposure to an ambient temperature of 95° Celsius. For an installation of the touch-sensitive screen 700 in a motor vehicle, therefore, the screen components and the processing thereof to form the screen 700 should be so chosen that they satisfy the mentioned requirements. It will be appreciated that alternative or additional requirements can also be made.

FIG. 7b shows a schematic representation of the fracture behaviour of the screen 700 according to FIG. 7a under the influence of the force represented by the arrow in FIG. 7a. According to the resemblance of the surface composite 701, 702, 703 of the screen 700 with the surface composite 500 of FIGS. 5a and 5b, corresponding observations on the latter's fracture behaviour also apply to the screen 700.

The described roughened glass surface 701 effectively reduces glares and sparkling of the screen 700. At the same time improved haptic properties in comparison with other materials and/or surface structures are thus achieved. It has further been found that the combination of the roughened surface 701 with a polarizer 705 closely underneath, i.e., in an upper section of the screen 700, leads to a considerable reduction of reflections from the screen. For example, if for the polarizer 705 a circular polarizer is used and supplemented by an underlying λ/2 layer, a deep-black appearance of the touch-sensitive screen 700 when the display 709 is switched off has been observed.

As a result of the described properties of the touch-sensitive screen 700, it is suitable, e.g., as part of an instrument or instrument system in a motor vehicle, such as, for example, a navigation system, an infotainment system or the like. The screen 700 is also suitable as part of a motor vehicle cockpit system (e.g., for displaying the speed and/or engine speed) and/or tablet PC for installation in a motor vehicle. The safety of the screen 700, e.g., permits installation in the preferred visual range, directly in front of the seat of a vehicle occupant (e.g. on the back of a driver's seat and/or passenger seat). Further fields of application of the touch-sensitive screen 700 are, however, not excluded.

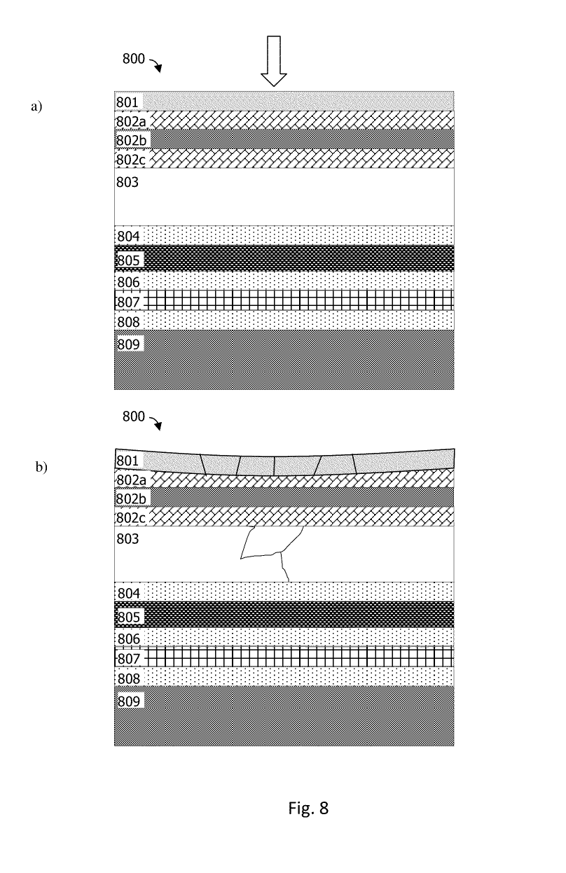

FIG. 8a shows an alternative embodiment of a touch-sensitive screen 800, e.g., for use in a motor vehicle, the screen 800 also having a surface composite of the described kind.

The constituents 803-809 in the lower parts of the screen 800 correspond to the constituents 703-709 of the screen 700 of FIG. 7a, respectively. However, the screen 800 differs from the screen 700 as it comprises a transparent flexible backing layer 802b embedded between transparent adhesive layers 802a, 802c underneath the transparent glass layer 801. The surface composite 801, 802a, 802b, 802c, 803 of the screen 800 shown in FIG. 8a thus resembles the surface composite 300 of FIGS. 3a and 3b. Consequently, the observations set forth in connection with the surface composite 300 of FIGS. 3a and 3b and the screen 700 of FIGS. 7a and 7b apply accordingly.

FIG. 8b shows a schematic representation of the fracture behaviour of the screen 800 according to FIG. 8a under the influence of the force represented by the arrow in FIG. 8a. Different from the screen 700 of FIG. 7b, in the present case the backing layer 802b helps to prevent shards of the broken rigid cover glass 803 to penetrate through the surface of the screen 800.

For a person skilled in the art it is evident that the glass surfaces that have been presented, certain constituents of which are a less rigid, thin glass layer and an underlying firm adhesion bonding, may find application also away from operating panels and visual displays, for instance for the purpose of surface embellishment in the interior of the vehicle or otherwise. In such an application as a decorative element some of the requirements that have been described, for example with respect to the transparency of the glass-surface composite, may cease to apply. Rather, in this connection some layers of the surface composite may have been stained. Furthermore, it would be conceivable to apply a decoration (e.g. a printed decoration) on the backing layer.

1. A glass-surface composite comprising:
a glass layer provided by way of surface, with a thickness between 20 μm and 400 μm;
a flexible backing layer; and
a first adhesive layer, the first adhesive layer connecting the glass layer to the backing layer two-dimensionally.

2. The glass-surface composite according to claim 1, wherein
the first adhesive layer exhibits a hardness between 0 Shore A and 60 Shore A.

3. The glass-surface composite according to claim 1, wherein the first adhesive layer exhibits a thickness between 5 μm and 600 μm.

4. The glass-surface composite according to claim 1, wherein the first adhesive layer comprises acrylic or silicone.

5. The glass-surface composite according to claim 1, wherein at least one side of the glass layer has been roughened.

6. The glass-surface composite according to claim 1, wherein the glass layer and/or the backing layer have/has been stained or provided with a decoration.

7. The glass-surface composite according to claim 1, wherein the backing layer exhibits a thickness between 50 μm and 500 μm.

8. The glass-surface composite according to claim 1, wherein the backing layer is tear-resistant and cut-resistant.

9. The glass-surface composite according to claim 1, wherein the backing layer includes at least one plastic film.

10. The glass-surface composite according to claim 1, wherein the backing layer includes an optical polarizer.

11. The glass-surface composite according to claim 1, wherein the backing layer includes a touch sensor.

12. The glass-surface composite according to claim 1,
further including
a subsurface; and
a second adhesive layer which connects the backing layer to the subsurface two-dimensionally.

13. The glass-surface composite according to claim 12, wherein
the subsurface is non-planar and wherein the overlying layers of the glass-surface composite have been moulded onto the subsurface.

14. The glass-surface composite according to claim 12, wherein
the subsurface is a rigid cover layer of at least one of a visual display and an operating panel.

15. The glass-surface composite according to claim 14, wherein
the rigid cover layer is a constituent of a covering for at least one of a visual display and an operating panel of a motor-vehicle instrument or motor-vehicle instrument system.

16. The glass-surface composite according to claim 14, wherein
the rigid cover layer exhibits a thickness between 0.2 mm and 2 mm.

17. The glass-surface composite according to claim 14, wherein
the rigid cover layer comprises one or more of polyethylene terephthalate, PET, polyamide, PA, polycarbonate, PC, polymethyl methacrylate, PMMA, and glass.

18. A tablet computer, including a glass-surface composite according to claim 1.

19. A touch-sensitive screen, comprising a glass-surface composite according to claim 1, the touch-sensitive screen further comprising:
a rigid cover layer arranged beneath the flexible backing layer of the glass-surface composite,
a polarization layer arranged beneath the rigid cover layer,
a touch sensor layer arranged beneath the polarization layer, and
a display of the touch-sensitive screen.

20. A glass-surface composite comprising:
a glass layer provided by way of surface, with a thickness between 20 μm and 400 μm;
a rigid cover layer; and
an adhesive layer which exhibits a thickness between 5 μm and 600 μm and also a hardness between 0 Shore A and 60 Shore A, the adhesive layer connecting the glass layer to the rigid cover layer two-dimensionally.

21. The glass-surface composite according to claim 20, wherein
the rigid cover layer is a constituent of a covering for a visual display and/or for an operating panel of a motor-vehicle instrument or motor-vehicle instrument system.

22. The glass-surface composite according to claim 20, wherein
the rigid cover layer exhibits a thickness between 0.2 mm and 2 mm.

23. The glass-surface composite according to claim 20, wherein the rigid cover layer comprises one or more of polyethylene terephthalate, PET, polyamide, PA, polycarbonate, PC, polymethyl methacrylate, PMMA, and glass.

24. A tablet computer, including a glass-surface composite according to claim 20.

25. A touch-sensitive screen, comprising a glass-surface composite according to claim 20, the touch-sensitive screen further comprising:
a polarization layer arranged beneath the rigid cover layer of the glass-surface composite,
a touch sensor layer arranged beneath the polarization layer, and
a display of the touch-sensitive screen.
